(19) United States
(12) Patent Application Publication
(10) Pub. No.: US 2014/0214332 A1
(43) Pub. Date: Jul. 31, 2014

(54) SYSTEM AND METHOD FOR RECOMBINATION OF GENOME SEQUENCE CONSIDERING READ LENGTH

(71) Applicant: SAMSUNG SDS CO., LTD., Seoul (KR)

(72) Inventor: Minseo PARK, Seoul (KR)

(73) Assignee: SAMSUNG SDS CO., LTD., Seoul (KR)

(21) Appl. No.: 14/142,059

(22) Filed: Dec. 27, 2013

(30) Foreign Application Priority Data
Jan. 29, 2013 (KR) 10-2013-0009790

(51) Int. Cl. G06F 19/22

(52) U.S. Cl. CPC G06F 19/22
USPC 702/19

(57) ABSTRACT

There are provided an apparatus for recombining genome sequence in consideration of a read length, and a method thereof. An exemplary embodiment of the sequence recombination apparatus includes a seed length calculating unit configured to calculate a seed length based on a read length of an input read, a seed generating unit configured to generate at least one seed having the seed length from the read, and an alignment unit configured to perform global alignment operation on a reference sequence of the read using the generated seed.

### CROSS-REFERENCE TO RELATED APPLICATION

This application claims priority to and the benefit of Republic of Korea Patent Application No. 10-2013-0009790 filed on Jan. 29, 2013, the disclosure of which is incorporated herein by reference in its entirety.

### BACKGROUND

1. Technical Field

The present disclosure relates to technology for generating a genome sequence by recombining fragmented sequences obtained from a sequencer.

2. Discussion of Related Art

Due to low costs and rapid data production, next generation sequencing (NGS) of producing a large number of short sequences quickly replaces a conventional Sanger sequencing method. In addition, various NGS sequence recombination programs have been developed focusing on accuracy. However, recently, as next generation sequencing technology develops, costs for producing fragmented sequences are less than half of those of the previous method. As the large volume of usable data is becoming available, technology for accurately and quickly processing a large number of short sequences became necessary.

In the first step of sequence recombination, a read is mapped to an accurate position of a reference sequence through a sequence alignment algorithm. A problem in this step is that there may be a difference of a genome sequence due to various genetic variations of the same species. In addition, there may be a difference due to errors in a sequencing process. Therefore, it is necessary to increase mapping accuracy through the sequence alignment algorithm in effective consideration of these differences and variations. As a result, in order to analyze genome information, as much accurate information data on entire genome as possible is necessary. To this end, above all, development of a sequence alignment algorithm having high accuracy and high throughput has to be preceded. However, existing methods have difficulties to satisfy these requirements.

### SUMMARY

Embodiments of the present disclosure are provided to extract an optimal seed in consideration of a mapping rate and accuracy when the read produced from the sequencer is aligned in the reference sequence.

According to an aspect of the present disclosure, there is provided a system and/or apparatus, intended for use in recombining genome sequence including a seed length calculating unit configured to calculate a seed length based on a read length of an input read; a seed generating unit configured to generate at least one seed having the seed length from the read; an alignment unit configured to perform global alignment operation on a reference sequence of the read using the generated seed; and a hardware processor configured to implement at least one of the seed length calculating unit, the seed generating unit, and the alignment unit.

The seed length may be set in proportion to the read length.

The seed length may be calculated using the following expression:

ceil[A×ln R_{length}+B−k₁]≦S_{length}≦ceil[A×ln R_{length}+B+k₂]

(where R_{length} represents a read length, S_{length} represents a seed length, A is a real number from 2.8 to 3.1, B is a real number from 2.6 to 3.0, k₁ and k₂ are real numbers from 0 to 4, and a ceiling function denoted by ceil(X) is the least integer greater than or equal to X).

The seed length may be within a range of 15 bp to 30 bp.

When the read length is 75 bp, the seed length calculated by the seed length calculating unit may be within a range of 15 bp to 17 bp.

When the read length is 100 bp, the seed length calculated by the seed length calculating unit may be within a range of 16 bp to 18 bp.

When the read length is 150 bp, the seed length calculated by the seed length calculating unit may be within a range of 17 bp to 19 bp.

The system and/or apparatus may further include a seed count calculating unit configured to calculate the number of seeds to be generated from the read according to the read length and the calculated seed length, wherein the seed generating unit may generate the seed from the read according to the calculated seed length and the number of seeds.

Wherein the number of seeds may be set in proportion to the read length and in inverse proportion to the seed length.

The number of seeds may be calculated using the following expression

ceil[R_{length}/S_{length}−k₃]≦Sₙᵤₘ≦ceil[R_{length}/S_{length}+k₄]

(where R_{length} represents a read length, S_{length} represents a seed length, Sₙᵤₘ represents the number of seeds, k₃ and k₄ are real numbers from 0 to 4, and a ceiling function denoted by ceil(X) is the least integer greater than or equal to X).

When the read length is 75 bp and the seed length is 16 bp, the number of seeds calculated by the seed count calculating unit may be in a range 4 to 6.

When the read length is 100 bp and the seed length is 16 bp, the number of seeds calculated by the seed count calculating unit may be within a range of 6 to 8.

When the read length is 150 bp and the seed length is 17 bp, the number of seeds calculated by the seed count calculating unit may be within a range of 8 to 10.

The system and/or apparatus of claim 8 may further include an overlap length calculating unit configured to calculate an overlap length of seeds to be generated from the read according to the read length, the seed length, and the number of seeds, wherein the seed generating unit may generate the seed from the read according to the calculated seed length, the number of seeds, and the overlap length.

The overlap length may be calculated using the following expression

$$ceil [ max ( \frac{{S}_{length} \times {S}_{num} - {R}_{length}}{{S}_{num} - 1} , 0 ) ] - {k}_{5} \leq overlap \leq ceil [ max ( \frac{{S}_{length} \times {S}_{num} - {R}_{length}}{{S}_{num} - 1} , 0 ) ] + {k}_{6}$$

(where overlap represents an overlap length, R_{length} represents a read length, S_{length} represents a seed length, Sₙᵤₘ represents the number of seeds, k₅ and k₆ are real numbers from 0 to 4, and a ceiling function denoted by ceil(X) is the least integer greater than or equal to X).

According to another aspect of the present disclosure, there is provided a method for recombining genome sequence, including calculating, by a seed length calculating unit, a seed length based on a read length of an input read; generating, by a seed generating unit, at least one seed having the seed length from the read; and performing, by an alignment unit, global alignment operation on a reference sequence of the read using the generated seed; wherein at least one of the seed length calculating unit, the seed generating unit, and the alignment unit is implemented by a hardware processor.

The seed length may be calculated in proportion to the read length.

The seed length may be calculated using the following expression:

ceil[A×ln R_{length}+B−k₁]≦S_{length}≦ceil[A×ln R_{length}+B+k₂]

(where R_{length} represents a read length, S_{length} represents a seed length, A is a real number from 2.8 to 3.1, B is a real number from 2.6 to 3.0, k₁ and k₂ are real numbers from 0 to 4, and a ceiling function denoted by ceil(X) is the least integer greater than or equal to X).

The seed length may be set within a range of 15 bp to 30 bp.

The method may further include calculating, by a seed count calculating unit, the number of seeds to be generated from the read according to the read length and the calculated seed length, after the calculating of the seed length is performed, wherein, in the generating of the seed, the seed may be generated from the read according the calculated seed length and the number of seeds.

The number of seeds may be set in proportion to the read length and in inverse proportion to the seed length.

The number of seeds may be calculated using the following Expression

ceil[R_{length}/S_{length}−k₃]≦Sₙᵤₘ≦ceil[R_{length}/S_{length}+k₄]

(where R_{length} represents a read length, S_{length} represents a seed length, Sₙᵤₘ represents the number of seeds, k₃ and k₄ are real numbers from 0 to 4, and a ceiling function denoted by ceil(X) is the least integer greater than or equal to X).

The method may further include calculating, by an overlap length calculating unit, an overlap length of seeds to be generated from the read according to the read length, the seed length, and the number of seeds, after the calculating of the number of seeds is performed, wherein, in the generating of the seed, the seed may be generated from the read according to the calculated seed length, the number of seeds, and the overlap length.

Wherein the overlap length may be calculated using the following expression

$$ceil [ max ( \frac{{S}_{length} \times {S}_{num} - {R}_{length}}{{S}_{num} - 1} , 0 ) ] - {k}_{5} \leq overlap \leq ceil [ max ( \frac{{S}_{length} \times {S}_{num} - {R}_{length}}{{S}_{num} - 1} , 0 ) ] + {k}_{6}$$

(where overlap represents an overlap length, R_{length} represents a read length, S_{length} represents a seed length, Sₙᵤₘ represents the number of seeds, k₅ and k₆ are real numbers from 0 to 4, and a ceiling function denoted by ceil(X) is the least integer greater than or equal to X).

### BRIEF DESCRIPTION OF DRAWINGS

FIG. 1 is a flowchart illustrating an exemplary embodiment of a sequence recombination method 100 according to the present disclosure;

FIG. 2 is a diagram illustrating an exemplary process of calculating the number of errors in a sequence alignment method according to the present disclosure;

FIG. 3 is a diagram illustrating an overlap between seeds according to an embodiment of the present disclosure;

FIGS. 4 and 5 are diagrams comparatively illustrating effects of an overlap length between seeds according to an embodiment of the present disclosure; and

FIG. 6 is a block diagram illustrating an exemplary embodiment of a sequence recombination system and/or apparatus 600 according to the present disclosure.

### DESCRIPTION OF EXAMPLE EMBODIMENTS

Hereinafter, exemplary embodiments of the present disclosure will be described in detail with reference to the drawings. However, these are only examples and the present disclosure is not limited thereto.

In descriptions of the present disclosure, when it is determined that detailed descriptions of related well-known functions may unnecessarily obscure the gist of the present disclosure, detailed descriptions thereof will be omitted. Some terms described in below are defined by considering functions in the present disclosure and meanings may vary depending on, for example, a user or operator's intentions or customs. Therefore, the meanings of terms should be interpreted based on the contents throughout this specification.

The spirit and scope of the present disclosure is defined by the appended claims. The following embodiments are only made to efficiently describe the technological scope of the present disclosure to those skilled in the art.

Before detailed description embodiments of the present disclosure, some terms used herein are defined as follows.

First, the term “read” refers to short-length sequence data that is output from a genome sequencer. In general, a length of the read varies from a 35 to 500 base pair (bp) depending on a type of the genome sequencer. To express a DNA nucleotide, letters of A, C, G, and T are generally used.

The term “reference sequence” refers to a sequence serving as a reference when an entire sequence is generated from the reads. In a sequence analysis, a large amount of reads output from the genome sequencer is mapped to the reference sequence and thus the entire sequence is completed. The reference sequence according to the present disclosure may include a predetermined sequence (for example, an entire sequence of the human) in the sequence analysis, or a sequence generated in the genome sequencer may also be used as the reference sequence.

The term “base” is a minimum unit that constitutes the reference sequence and the read. As described above, the DNA nucleotide may include four English letters of A, C, G, and T, and each of them is expressed as the base. That is, the DNA nucleotide is expressed as four bases and the same as in the read.

The term “seed” is a sequence serving as a unit when the read and the reference sequence are compared for read mapping. Theoretically, in order to map the read to the reference sequence, it is necessary to calculate a mapping position of the read by sequentially comparing from a first part of the reference sequence with an entire read. However, in this method, much time and computing power is necessary to map a single read. Therefore, in reality, the seed, that is a fragment including some of the read, is mapped first to the reference sequence, and thus a mapping candidate position of the entire read is found and the entire read is mapped to a corresponding candidate position (global alignment).

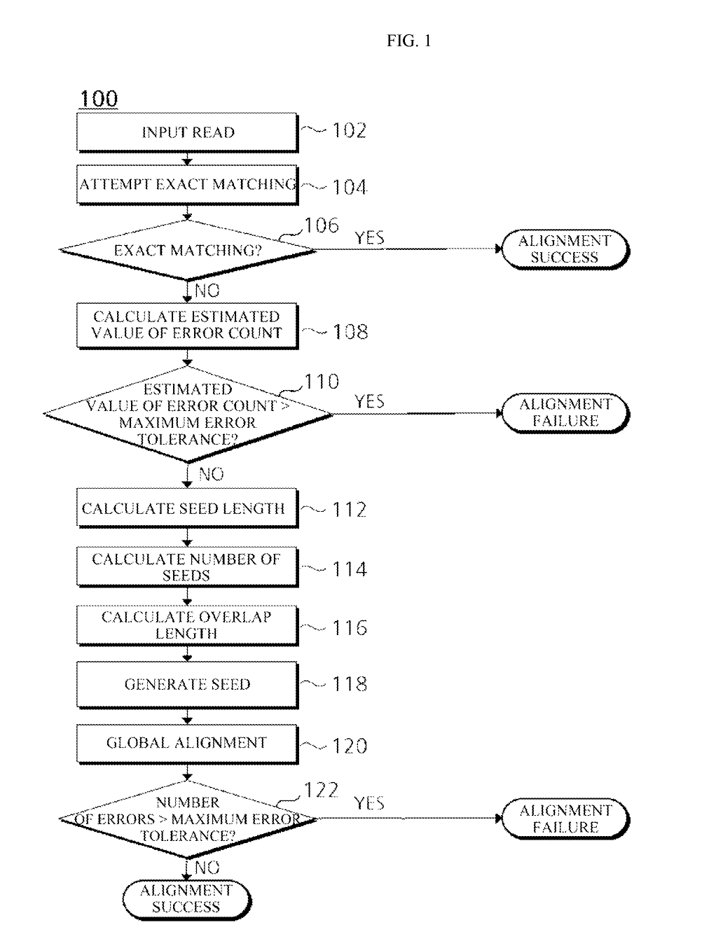

FIG. 1 is a diagram illustrating a sequence recombination method 100 according to an embodiment of the present disclosure. According to the embodiment of the present disclosure, the sequence recombination method 100 refers to a series of processes in which the read output from the genome sequencer is compared with the reference sequence and a mapping (or alignment) position in the reference sequence of the read is determined.

First, when the read is input from the genome sequencer (102), exact matching of the entire read and the reference sequence is attempted (104). When exact matching of the entire read is successful as a result of operation of 102, the following alignment operation is not performed and it is determined that the alignment is successful (106). An experimental result of a human genome sequence shows that, when exact matching of 1 million reads output from the genome sequencer and the human sequence is performed, 231,564 times of exact matching are generated out of 2 million times of alignments in total (1 million times of forward sequences and 1 million times of reverse complement sequences). Therefore, alignment requirements of about 11.6% could be reduced as a result of operation of 104.

On the other hand, when it is determined that exact matching of a corresponding read is not generated in operation of 106, the estimated number of errors when the corresponding read is aligned in the reference sequence is calculated (108).

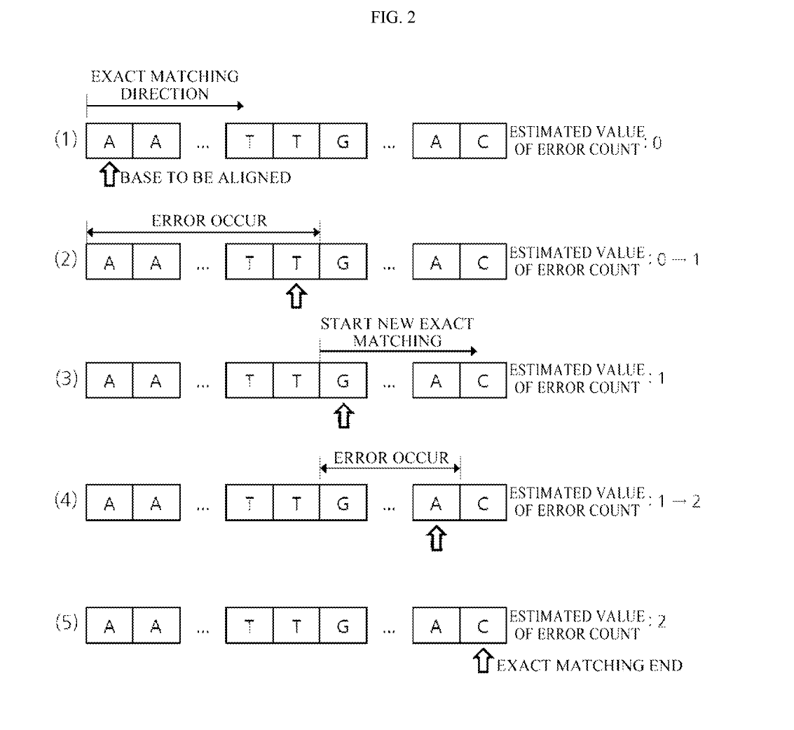

FIG. 2 is a diagram illustrating an exemplary process of estimating the number of errors in operation of 108. First, as illustrated in FIG. 2 (1), an initial estimated value of an error count is set to 0, and exact matching is attempted moving along from a first base to an end of the read by one base. In this case, as illustrated in FIG. 2 (2), it is assumed that no exact matching occurs from a specific base (a part indicated as a second T in the drawing) of the read. This case means that an error occurred in somewhere between an initial matching position of the read and a current position. Therefore, in this case, the estimated value of the error count is increased by one, and new exact matching is attempted in the next position (indicated in FIG. 2 (3)). Then, when it is determined again that no exact matching occurs in a specific position, this means that an error occurred in somewhere between a position in which exact matching is newly started and a current position. Accordingly, the estimated value of the error count is increased by one again, and new exact matching is attempted in the next position (indicated in FIG. 2 (4)). When exact matching is performed until the end of the read through these processes, the estimated value of the error count is the number of errors that can be present in the corresponding read.

When the estimated value of the error count of the read is calculated through the above processes, it is determined whether the calculated estimated value of the error count exceeds a predetermined maximum error tolerance (maxError) (110). When it is determined that the calculated estimated value of the error count exceeds the predetermined maximum error tolerance, alignment of the read is determined as a failure and thus the alignment ends. In the experiment of the human sequence, the maximum error tolerance (maxError) is set to 3 and an estimated value of an error count of other reads is calculated. The result showed that 844,891 reads in total exceed the maximum error tolerance. That is, as a result of operations of 108 and 110, alignment requirements of about 42.2% could be reduced.

On the other hand, as a result of operation of 110, when it is determined that the estimated value of the error count is less than or equal to the maximum error tolerance, a length of a seed to be generated from the read (112), the number of seeds to be generated (114), and an overlap length between seeds (116) are calculated using a length of the read. Then, the calculated seed length, number of seeds, and overlap length are used to generate a seed from the read (118), and global alignment operation is performed on the generated read (120). In this case, when the number of errors of the read exceeds the predetermined maximum error tolerance (maxError) based on a result of the global alignment operation, it is determined as an alignment failure, and otherwise, as an alignment success (122).

Hereinafter, a process of determining the overlap length, the number of seeds, and the seed length to be extracted from the read length in operations of 112 to 116 will be described in detail.

Calculation of Seed Length

According to the embodiment of the present disclosure, a length of the seed calculated from the read is determined by a length of the read. As the read length increases, the seed length increases in a kind of proportional relation. Specifically, the seed length may be determined by the following Expression 1.

ceil[A×ln R_{length}+B−k₁]≦S_{length}≦ceil[A×ln R_{length}+B+k₂] Expression 1

In this case, R_{length} represents a read length, S_{length} represents a seed length, and A, B, k₁, and k₂ are parameters for setting a specific proportional relation between the seed and the read. A range of each parameter may differ according to types of the read and the reference sequence. However, it is preferable that each of the parameters have the following range in most DNA sequences.

A: real number from 2.8 to 3.1

B: real number from 2.6 to 3.0

k₁ and k₂: real numbers from 0 to 4

Meanwhile, a ceiling function denoted by ceil (X) refers to the least integer greater than or equal to X in the above Expression.

For example, when it is assumed that A=2.966, B=2.804, and k₁=k₂=0, if a read length is 100, a seed length is ceil[2.966×ln(100)+2.804]=ceil(16.4629)=17. If a read length is 500, a seed length is ceil[2.966×ln(500)+2.804]=ceil(21.2365)=22.

In addition, when it is assumed that A=2.966, B=2.804, and k₁=k₂=1, the seed length according to the read length calculated by the above Expression 1 includes the following range.

i) If read length is 75 bp, 15 bp≦seed length≦17 bp
ii) If read length is 100 bp, 16 bp≦seed length≦18 bp
iii) If read length is 150 bp, 17 bp≦seed length≦19 bp
iv) If read length is 500 bp, 21 bp≦seed length≦23 bp

In general, the shorter the seed length, the greater the number of mapping of the seed in the reference sequence, and the longer the seed length, the lower the number of mapping of the seed in the reference sequence. In other words, when the seed length generated from the read is shorter than the range of the above Expression 1, the number of mapping of the seed in the reference sequence excessively increases. Then, there is a problem in that the number of global alignments unnecessarily increases in a later global alignment process. On the other hand, when the seed length is greater than the range of the above expression 1, the number of mapping of the seed in the reference sequence excessively decreases. As a result, mapping accuracy decreases. According to the present disclosure, the seed length is set according to the above Expression 1 in consideration of the read length. Therefore, it is possible to guarantee a mapping quality and minimize complexity that can be generated in mapping.

In addition, when the reference sequence is the human sequence, the seed may be set 15 bp to 30 bp. As described above, in general, the shorter the seed length, the greater the number of mapping of the seed in the reference sequence, and the longer the seed length, the lower the number of mapping of the seed in the reference sequence. In particular, in the human sequence, when the seed length is less than or equal to 14, the number of mapping positions in the reference sequence significantly increases. The following Table 1 shows average appearance frequencies of the seed in the human genome according to the seed length.

TABLE 1

| Seed length | Average appearance frequency |
|---|---|
| 10 | 2,726.1919 |
| 11 | 681.9731 |
| 12 | 170.9185 |
| 13 | 42.7099 |
| 14 | 10.6470 |
| 15 | 2.6617 |
| 16 | 0.6654 |
| 17 | 0.1664 |

As shown in Table 1, when the seed length is less than or equal to 14, the average appearance frequency in the reference sequence for each seed is greater than or equal to 10. However, when the seed length is 15, the average appearance frequency decreases to less than or equal to 3. When the seed length is greater than or equal to 15, it is possible to significantly reduce a seed overlap compared when the seed length of 14 or lower is used. In addition, when the seed length is greater than or equal to 30, the number of mapping of the seed in the reference sequence excessively decreases and thus mapping accuracy decreases. Therefore, in the present disclosure, the seed length is set 15 to 30 when the human sequence is used as the reference sequence. As a result, it is possible to guarantee a mapping quality and minimize complexity that can be generated in mapping.

Calculation of the Number of Seeds

When the seed length is determined using the above method, the read length and seed length are used to calculate the number of seeds to be extracted from the read.

According to the embodiment of the present disclosure, the number of seeds calculated from the read is determined according to the read length and the seed length to be extracted from the read. Specifically, the number of seeds increases as the read length becomes longer in a kind of proportional relation, and the number of seeds decreases as the seed length becomes longer in a kind of inverse proportional relation. Specifically, the number of seeds may be determined by the following Expression 2.

ceil[R_{length}/S_{length}−k₃]≦Sₙᵤₘ≦ceil[R_{length}/S_{length}+k₄] Expression 2

In this case, R_{length} represents a read length, S_{length} represents a seed length, Sₙᵤₘ represents the number of seeds, and k₃ and k₄ are parameters for setting a range of the number of seeds and may be set to real numbers from 0 to 4. A ceiling function denoted by ceil (X) refers to the least integer greater than or equal to X.

For example, when it is assumed that k₃=k₄=1, the number of seeds according to the read length and the seed length is determined as follows.

1) If read length is 100 and seed length is 16
ceil(100/16−1)=ceil(5.25)=6
ceil(100/16+1)=ceil(7.25)=8
therefore, 6≦the number of seeds≦8
   2) If read length is 75 and seed length is 16
ceil(75/15−1)=ceil(3.6875)=4
ceil(75/15+1)=ceil(5.6875)=6
therefore, 4≦the number of seeds≦6
   3) If read length is 150 and seed length is 17
ceil(150/17−1)=ceil(7.823)=8
ceil(150/17+1)=ceil(9.823)=10
therefore, 8≦the number of seeds≦10

Calculation of Overlap Length

When the seed length and the number of seeds are determined using the above method, an overlap length of the seed to be extracted from the read is calculated.

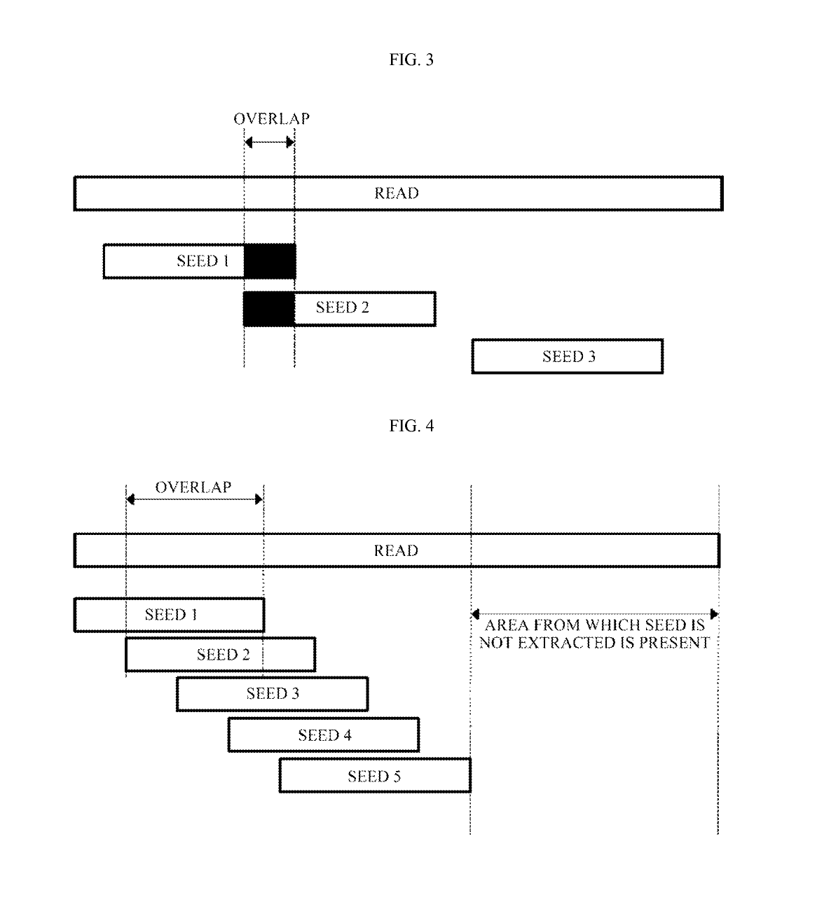

FIG. 3 is a diagram illustrating an overlap between seeds according to the present disclosure. As illustrated, in the embodiment of the present disclosure, the overlap between seeds refers to an area in which seeds overlap each other, in other words, an area commonly shared by two seeds. For example, as illustrated, seed 1 and seed 2 commonly share an area indicated by a gray shade, and thus this area becomes an overlap area between two seeds. In addition, an overlap length refers to a length of the area overlapping (overlap area) between two seeds. For example, in the illustrated embodiment, when seed 1 includes 5 to 19th bases of the read and seed 2 includes 16 to 30th bases of the read, an overlap area between seeds 1 and 2 includes 16 to 19th bases, and thus the overlap length is 4. Meanwhile, there is no overlap area between seed 2 and seed 3, and thus the overlap length between the two seeds is 0.

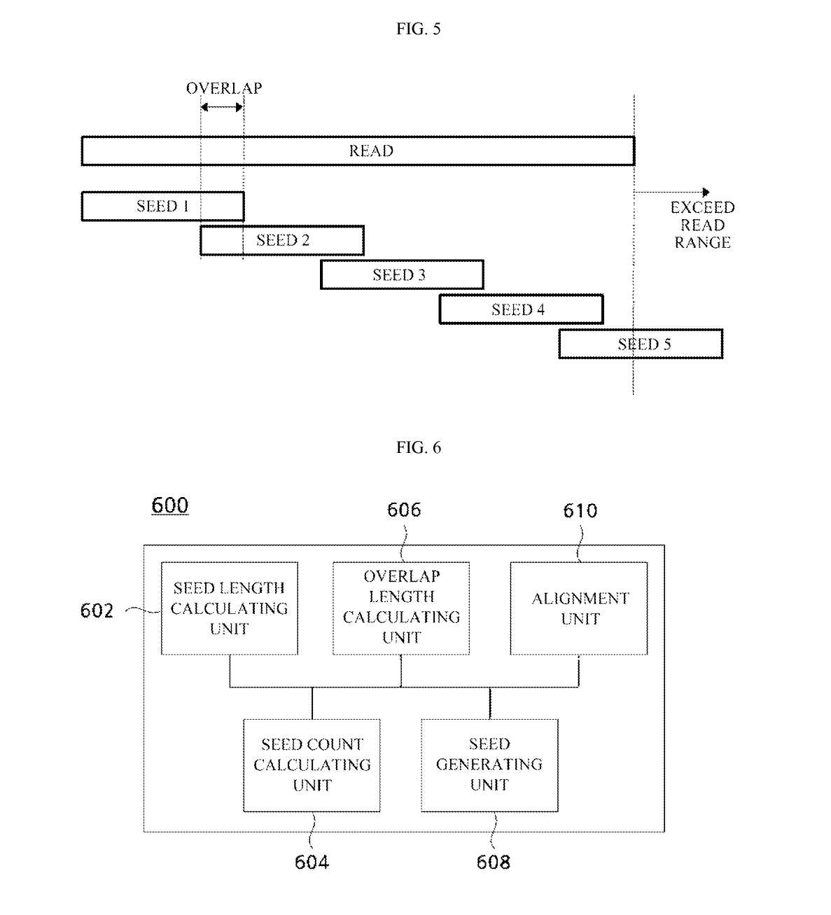

FIGS. 4 and 5 are diagrams comparatively illustrating effects of an overlap length between seeds according to an embodiment of the present disclosure. For example, as illustrated in FIG. 4, when the overlap length between seeds is set to be excessively large, since the seed is extracted from only some of the read, there is an area, that is not extracted as the seed, in the read. On the other hand, as illustrated in FIG. 5, when the overlap length between seeds is set to be excessively small, since some of the seed is outside a read length range, it is impossible to extract the seed from the read. Therefore, according to the embodiment of the present disclosure, in consideration of these cases, it is possible to determine the overlap length so as to maximize an area in which the seed is extracted from the read and not to exceed the read range.

According to the embodiment of the present disclosure, the overlap length between seeds is determined according to an input read length, the number of seeds, and the seed length. Specifically, the overlap length may be determined by the following Expression 3.

$$ceil [ max ( \frac{{S}_{length} \times {S}_{num} - {R}_{length}}{{S}_{num} - 1} , 0 ) ] - {k}_{5} \leq overlap \leq ceil [ max ( \frac{{S}_{length} \times {S}_{num} - {R}_{length}}{{S}_{num} - 1} , 0 ) ] + {k}_{6} \qquad Expression 3$$

In this case, overlap represents a length of the overlap, R_{length} represents a read length, S_{length} represents a seed length, Sₙᵤₘ represents the number of seeds, and k₅ and k₆ are parameters for setting an overlap length range and may be set to integers from 0 to 4. A ceiling function denoted by ceil(X) refers to the least integer greater than or equal to X.

Meanwhile, since the overlap length cannot be a negative number by definition, k₅ and k₆ need to satisfy the following range.

$$ceil [ max ( \frac{{S}_{length} \times {S}_{num} - {R}_{length}}{{S}_{num} - 1} , 0 ) ] \geq {k}_{5} , {k}_{6} \qquad Expression 4$$

For example, it is assumed that k₅=k₆=0. When the read length is 75, the seed length is 16, and the number of seeds is 5, the overlap length may be determined by the above Expression 3.

overlap length=ceil(max(16×5−75/4,0))=ceil(1.25)=2

Meanwhile, a specific method of generating the seed from the read is not specifically limited in the present disclosure. That is, in operation of 118, in consideration of some or an entire read, a plurality of seeds having the length, the number, and the overlap length calculated in operations of 112 to 116 are generated. For example, seeds may be generated such that the entire read or a specific area of the read is divided into a plurality of fragments or divided fragments are combined. In this case, the generated seeds may be consecutively connected but is not necessarily. It is also possible to generate the seeds by combining fragments separated from each other in the read. In short, the method of generating the seed from the read is not specifically limited in the present disclosure, and various algorithms for extracting the seed from the entire read or some read may be used without limitation.

FIG. 6 is a block diagram illustrating a sequence recombination system and/or apparatus 600 according to an embodiment of the present disclosure. The sequence recombination system and/or apparatus 600 according to the embodiment of the present disclosure is a device for performing the above sequence recombination method, includes a seed length calculating unit 602, a seed generating unit 608, and an alignment unit 610, and may further include a seed count calculating unit 604 and an overlap length calculating unit 606 as necessary.

The seed length calculating unit 602 calculates a length of the seed to be generated from the read according to an input read length. As described above, the seed length may be set in proportion to the read length, and specifically, the seed length may be calculated using the above Expression 1.

The seed count calculating unit 604 calculates the number of seeds to be generated from the read according to the read length and the seed length calculated by the seed length calculating unit 602. The number of seeds may be set in proportion to the read length and in inverse proportion to the seed length, and specifically, the number of seeds may be calculated using the above Expression 2.

The overlap length calculating unit 606 calculates an overlap length of seeds to be generated from the read according to the read length, the seed length, and the number of seeds. In this case, the overlap length may be calculated using the above Expression 3.

The seed generating unit 608 generates the seed from the read according to the calculated seed length, the number of seeds, and the overlap length.

The alignment unit 610 performs global alignment operation on the reference sequence using the seed generated by the seed generating unit 608.

Meanwhile, exemplary embodiments of the present disclosure may include a computer-readable recording medium including a program for performing the methods, described herein, using a general purpose or specialized computer. The computer-readable recording medium may separately include program commands, local data files, local data structures, etc. or include a combination of them. The medium may be specially designed and configured for the present disclosure, or known and available to those of ordinary skill in the field of computer software. Examples of the computer-readable recording medium, in a non-transitory aspect, include magnetic media, such as a hard disk, a floppy disk, and a magnetic tape, optical recording media, such as a CD-ROM and a DVD, magneto-optical media, such as a floptical disk, and hardware devices, such as a ROM, a RAM, and a flash memory, specially configured to store and perform program commands. Examples of the program commands may include high-level language codes executable by a computer using an interpreter, etc. as well as machine language codes made by compilers. Inasmuch as a computer is a device that is well known to those familiar with this field, a detailed description, of the hardware processor of such a computer, or of the manner in which the computer-readable recording medium may be employed to implement the various devices or units, and to control the variously described operations using the processor, is not provided. Likewise, a description of well known output devices such as displays, printers, data files on magnetic or optical media, and the like, for outputting results, is also not provided.

According to the embodiments of the present disclosure, in consideration of a length of the read output from the sequencer, an optimal seed length, the number of seeds, and the overlap length are calculated, and the seed is extracted from the read based on a calculation result. As a result, it is possible to guarantee accuracy of sequence alignment and increase an alignment rate.

While the present disclosure has been described with reference to exemplary embodiments, it will be understood by those skilled in the art that various modifications may be made without departing from the scope and sprit of the present disclosure.

Therefore, the scope of the present disclosure is not defined by the described embodiments but by the appended claims and encompasses equivalents that fall within the scope of the appended claims.

What is claimed is:

1. An apparatus, intended for use in recombining a genome sequence, comprising:
a seed length calculating unit configured to calculate a seed length, based on a read length of an input read, to provide a calculated seed length;
a seed generating unit configured to generate one or more seeds, each having the calculated seed length, to provide at least one generated seed;
an alignment unit configured to perform a global alignment operation, on a reference sequence of the input read, using the generated seed; and
a hardware processor configured to implement at least one of the seed length calculating unit, the seed generating unit, and the alignment unit.

2. The apparatus of claim 1, wherein the seed length calculating unit is further configured to set the seed length in proportion to the read length.

3. The apparatus of claim 1, wherein the seed length calculating unit is further configured to calculate the seed length in accordance with the following expression:
ceil[A×ln R_{length}+B−k₁]≦S_{length}≦ceil[A×ln R_{length}+B+k₂]
where:
R_{length} represents the read length,
S_{length} represents the seed length,
A is a real number from 2.8 to 3.1,
B is a real number from 2.6 to 3.0,
k₁ and k₂ are real numbers from 0 to 4, and
the ceiling function ceil(X) is the least integer greater than or equal to X.

4. The apparatus of claim 3, wherein the calculating unit is further configured to calculate the seed length, in accordance with the expression, to fall within a range of 15 bp to 30 bp.

5. The apparatus of claim 1, wherein the seed length calculating unit is further configured to provide the calculated seed length within a range of 15 bp to 17 bp when the read length is 75 bp.

6. The apparatus of claim 1, wherein the seed length calculating unit is further configured to provide the calculated seed length within a range of 16 bp to 18 bp when the read length is 100 bp.

7. The apparatus of claim 1, wherein the seed length calculating unit is further configured to provide the calculated seed length within a range of 17 bp to 19 bp when the read length is 150 bp.

8. The apparatus of claim 1, further comprising a seed count calculating unit configured to calculate a number of seeds to be generated from the read, based on the read length and the calculated seed length, wherein the seed generating unit is further configured to generate the one or more seeds in accordance with the number of seeds to be generated.

9. The apparatus of claim 8, wherein the seed count calculating unit is further configured to set the number of seeds in proportion to the read length and in inverse proportion to the seed length.

10. The apparatus of claim 8, wherein the seed count calculating unit is further configured to calculate the number of seeds in accordance with the following expression
ceil[R_{length}/S_{length}−k₃]≦Sₙᵤₘ≦ceil[R_{length}/S_{length}+k₄]
where:
R_{length} represents the read length,
S_{length} represents the seed length,
Sₙᵤₘ represents the number of seeds,
k₃ and k₄ are real numbers from 0 to 4, and
the ceiling function ceil(X) is the least integer greater than or equal to X.

11. The apparatus of claim 8, wherein, when the read length is 75 bp and the seed length is 16 bp, the number of seeds calculated by the seed count calculating unit is in a range 4 to 6.

12. The apparatus of claim 8, wherein the seed count calculating unit is further configured to provide the number of seeds within a range of 6 to 8 when the read length is 100 bp and the seed length is 16 bp.

13. The apparatus of claim 8, wherein the seed count calculating unit is further configured to provide the number of seeds within a range of 8 to 10 when the read length is 150 bp and the seed length is 17 bp.

14. The apparatus of claim 8, further comprising an overlap length calculating unit configured to calculate an overlap length, of seeds to be generated from the read, based on the read length, the seed length, and the number of seeds, wherein the seed generating unit generates the one or more seeds from the read in accordance with the calculated seed length, the number of seeds, and the overlap length.

15. The apparatus of claim 14, wherein the overlap length is calculated in accordance with the following expression
$$ceil [ max ( \frac{{S}_{length} \times {S}_{num} - {R}_{length}}{{S}_{num} - 1} , 0 ) ] - {k}_{5} \leq overlap \leq ceil [ max ( \frac{{S}_{length} \times {S}_{num} - {R}_{length}}{{S}_{num} - 1} , 0 ) ] + {k}_{6}$$
where:
overlap represents the overlap length,
R_{length} represents the read length,
S_{length} represents the seed length,
Sₙᵤₘ represents the number of seeds,
k₅ and k₆ are real numbers from 0 to 4, and
the ceiling function ceil(X) is the least integer greater than or equal to X.

16. A method for recombining a genome sequence, comprising:
calculating, by a seed length calculating unit, a seed length, based on a read length of an input read, to provide a calculated seed length;
generating, by a seed generating unit, one or more seeds, each having the calculated seed length, to provide at least one generated seed; and
performing, by an alignment unit, a global alignment operation on a reference sequence of the input read, using the generated seed;
wherein at least one of the seed length calculating unit, the seed generating unit, and the alignment unit is implemented by a hardware processor.

17. The method of claim 16, wherein the seed length is set in proportion to the read length.

18. The method of claim 16, wherein the calculating of the seed length is performed in accordance with the following expression
ceil[A×ln R_{length}+B−k₁]≦S_{length}≦ceil[A×ln R_{length}+B+k₂]
where:
R_{length} represents the read length,
S_{length} represents the seed length,
A is a real number from 2.8 to 3.1,
B is a real number from 2.6 to 3.0,
k₁ and k₂ are real numbers from 0 to 4, and
the ceiling function ceil(X) is the least integer greater than or equal to X).

19. The method of claim 18, wherein the seed length is set within a range of 15 bp to 30 bp.

20. The method of claim 16, further comprising calculating, by a seed count calculating unit, a number of seeds to be generated from the read, according to the read length and the calculated seed length, after the calculating of the seed length is performed, wherein, the generating of the one or more seeds is performed in accordance with the number of seeds.

21. The method of claim 20, wherein the number of seeds is set in proportion to the read length and in inverse proportion to the seed length.

22. The method of claim 20, wherein the number of seeds is calculated in accordance with the following Expression
ceil[R_{length}/S_{length}−k₃]≦Sₙᵤₘ≦ceil[R_{length}/S_{length}+k₄]
where:
R_{length} represents the read length,
S_{length} represents the seed length,
Sₙᵤₘ represents the number of seeds,
k₃ and k₄ are real numbers from 0 to 4, and
the ceiling function ceil(X) is the least integer greater than or equal to X.

23. The method of claim 20, further comprising calculating, by an overlap length calculating unit, an overlap length, of seeds to be generated from the read, based on the read length, the seed length, and the number of seeds, after the calculating of the number of seeds is performed, wherein, the generating of the one or more seeds from the read is performed in accordance with the calculated seed length, the number of seeds, and the overlap length.

24. The method of claim 23, wherein the overlap length is calculated in accordance with the following expression
$$ceil [ max ( \frac{{S}_{length} \times {S}_{num} - {R}_{length}}{{S}_{num} - 1} , 0 ) ] - {k}_{5} \leq overlap \leq ceil [ max ( \frac{{S}_{length} \times {S}_{num} - {R}_{length}}{{S}_{num} - 1} , 0 ) ] + {k}_{6}$$
where:
overlap represents the overlap length,
R_{length} represents the read length,
S_{length} represents the seed length,
Sₙᵤₘ represents the number of seeds,
k₅ and k₆ are real numbers from 0 to 4, and
the ceiling function ceil(X) is the least integer greater than or equal to X.
